(19) United States
(12) Patent Application Publication
(10) Pub. No.: US 2023/0103472 A1
(43) Pub. Date: Apr. 6, 2023

(54) MIXING ASSEMBLY FOR A CONTAINER AND METHOD OF OPERATING THE SAME

(71) Applicant: ATKINS NUCLEAR SECURED HOLDINGS CORPORATION, Oak Ridge, TN (US)

(72) Inventors: Don Mark GERBOTH, Oak Ridge, TN (US); Gordon CRAWFORD, Oak Ridge, TN (US); John RICHARDSON, Oak Ridge, TN (US)

(73) Assignee: ATKINS NUCLEAR SECURED HOLDINGS CORPORATION, Oak Ridge, TN (US)

(21) Appl. No.: 17/907,194

(22) PCT Filed: Feb. 26, 2021
(86) PCT No.: PCT/US2021/020019

§ 371 Date: Sep. 23, 2022

Related U.S. Application Data
(60) Provisional application No. 62/993,511, filed on Mar. 23, 2020.

(51) Int. Cl. B09B 3/38; B01F 27/191; B01F 27/213; B01F 27/906

(52) U.S. Cl. CPC B09B 3/38; B01F 27/191; B01F 27/213; B01F 27/906

(57) ABSTRACT

A sacrificial mixing assembly for a container and a method of operating the same. The mixing assembly includes an alignment assembly and a paddle assembly. The alignment assembly includes an alignment dish having a geometric shape substantially similar to a base of the container and an alignment shaft projecting from the dish surface. The paddle assembly includes an elongate section for engaging with the alignment shaft and a plurality of blades projecting from the elongate section for mixing contents contained within the container. The mixing assembly is containable within the container and rotatable about the alignment shaft. The alignment dish is dimensioned to interface with the base of the container to reduce annular motion about the alignment shaft during rotation of the paddle assembly about the alignment shaft.

### CROSS REFERENCE TO RELATED APPLICATIONS

This application claims priority from U.S. provisional patent application No. 62/993,511, entitled “MIXING ASSEMBLY FOR A CONTAINER AND METHOD OF OPERATING THE SAME”, filed on Mar. 23, 2020, the entire contents of which are hereby incorporated by reference herein.

### FIELD

The present disclosure generally relates to a mixing assembly and, in particular to a mixing assembly for a container and a method of operating the mixing assembly.

### BACKGROUND

Waste materials hazardous to the environment and to humans may include nuclear waste, among other types of waste. In some situations, waste materials may be immobilized as a solid matrix, making the waste less susceptible to leaking or leaching out of a containment apparatus into the environment. In some examples, methods of immobilizing waste materials may include mixing waste materials with immobilization reagents.

### SUMMARY

Embodiments of the present disclosure may provide mixing assemblies for positioning within readily available containers for containing hazardous waste materials. Embodiments of the present disclosure may provide alignment assemblies that may be adaptable to numerous container geometries or dimensions for providing support to paddle assemblies within containers without structural features modifying the external structural features or integrity of the containers. As external features or structural integrity of the containers need not be altered, re-certification testing based on regulatory standards of containers for waste transportation, disposal, etc. may not be required.

In some examples, one or more components of embodiment mixing assemblies may be disposed of in combination with immobilized waste materials upon the mixing assemblies being used to mix waste materials with an immobilization reagent.

In one aspect, the present disclosure describes a mixing assembly for a container. The mixing assembly may include an alignment dish including a dish surface; an alignment shaft projecting from the dish surface; and a paddle assembly coupled to the alignment shaft. The paddle assembly may include an elongate section for engaging with the alignment shaft, the elongate section having a length greater than an alignment shaft length of the alignment shaft; and a plurality of blades projecting from the elongate section for mixing contents contained within the container, the plurality of blades distributed about an annular direction on the elongate section, wherein the paddle assembly is containable within the container and rotatable about the alignment shaft, and wherein the alignment dish is dimensioned to interface with the base of the container to reduce annular motion about the alignment shaft during rotation of the paddle assembly about the alignment shaft.

In some embodiments, the paddle assembly containable within the container may be retained within the container for storage or disposal.

In some embodiments, the alignment dish surface may be configured to have a geometric shape substantially similar to a base of the container.

In some embodiments, the elongate section for engaging the alignment shaft may be an elongate hollow section for receiving the alignment shaft therein.

In some embodiments, the alignment dish may be configured to be positioned adjacent the base of the container and maybe concentric with the base of the container, wherein the alignment dish is removably positioned adjacent the base of the container.

In some embodiments, the elongate section may include a sleeve positioned between at least a portion of the elongate section and the alignment shaft.

In some embodiments, the sleeve may include polytetrafluoroethylene (PTFE) tubing.

In some embodiments, the alignment dish may include one or more projections coupled to the dish surface.

In some embodiments, the one or more projections may include at least one of a slat, louver, or a triangular prism.

In some embodiments, the alignment shaft is affixed to the alignment dish based on at least one of a seal weld and a tack weld.

In some embodiments, the mixing assembly may include a washer positioned between the elongate section and the alignment dish when the alignment shaft is received within the elongate section.

In some embodiments, the elongate section includes an elongate rectangular tube.

In some embodiments, the alignment shaft includes a carbon steel post.

In some embodiments, the alignment shaft includes a tapered end positioned proximal to an opening of the container.

In some embodiments, the mixing assembly includes an annular brush coupled to a second end of the elongate section configured to reduce displacement of the contents from an opening of the container.

In another aspect, the present disclosure describes a paddle assembly for a container. The paddle assembly may include: an elongate section for engaging with an alignment shaft positioned within the container and projecting from an alignment dish positioned in a base of the container, the elongate section having a length greater than an alignment shaft length of the alignment shaft; and a plurality of blades projecting from the elongate section for mixing contents contained within the container, the blades distributed about an annular direction on the elongate section, and wherein the paddle assembly is containable within the container and rotatable about the alignment shaft, and wherein during rotation of the paddle assembly about the alignment shaft, the alignment dish is substantially stationary in an annular direction relative to the alignment shaft

In some embodiments, the elongate section for engaging with the alignment shaft may be an elongate hollow section for receiving the alignment shaft therein.

In some embodiments, the elongate section includes a sleeve, wherein the sleeve is positioned between at least a portion of the elongate section and the alignment shaft during rotation of the paddle assembly about the alignment shaft.

In some embodiments, the sleeve may include polytetrafluoroethylene tubing.

In some embodiments, the elongate section may include an elongate rectangular tube.

In some embodiments, the paddle assembly may include a washer positioned between the elongate section and the alignment dish when the alignment shaft is received within the elongate section.

In some embodiments, the paddle assembly may include comprising an annular brush coupled to a second end of the elongate section configured to reduce displacement of the contents from an opening of the container.

In another aspect, the present disclosure may provide a method of mixing a substance within a container. The method may include: positioning a mixing assembly within the container, the mixing assembly including a paddle assembly, wherein the paddle assembly includes an elongate section engaging with an alignment shaft positioned within the container and projecting from an alignment dish positioned in a base of the container, the elongate section having a length greater than an alignment shaft length of the alignment shaft; coupling an external drive apparatus to the mixing assembly via the elongate section; and rotating, via the external drive apparatus, the mixing assembly within the container.

In some embodiments, the elongate section engaging with an alignment shaft is an elongate hollow section.

In some embodiments, the method may include decoupling the elongate section of the external drive apparatus; and securing a lid to the opening of the container to contain the mixing assembly and the mixed substance within the container for storage or disposal.

In some embodiments, the method may include inserting, into the container, an immobilization reagent for mixing with the contents within the container.

In some embodiments, positioning the mixing assembly within the container includes positioning the alignment dish within the base of the container such that the alignment shaft is positioned at a centroid of the base of the container, and wherein rotating the mixing assembly within the container includes rotating the paddle assembly concentric with the base of the container.

In some embodiments, coupling the external drive apparatus to the mixing assembly via the elongate section may include mating a socket-shaped shaft end of the external drive apparatus to a coupling end of the elongate section.

In some embodiments, coupling the external drive apparatus to the mixing assembly via the elongate section may include inserting an external drive apparatus shaft end within a recessed end of the elongate section.

The term “connected” or “coupled to” may include both direct coupling (in which two elements that are coupled to each other contact each other) and indirect coupling (in which at least one additional element is located between the two elements). The terms “a” and “an” are defined as one or more unless this disclosure explicitly requires otherwise. The terms “substantially” and “approximately” are each defined as largely but not necessarily wholly what is specified—and include what is specified; e.g., substantially or approximately 90 degrees includes 90 degrees and substantially or approximately parallel includes parallel—as understood by a person of ordinary skill in the art. In any disclosed embodiment, the terms “substantially” and “approximately” may be substituted with “within [a percentage] of” what is specified, where the percentage includes 0.1, 1, 5, and 10 percent.

The terms “comprise” and any form thereof such as “comprises” and “comprising,” “have” and any form thereof such as “has” and “having,” “include” and any form thereof such as “includes” and “including,” and “contain” and any form thereof such as “contains” and “containing,” are open-ended linking verbs. As a result, an apparatus that “comprises,” “has,” “includes,” or “contains” one or more elements possesses or contains those one or more elements, but is not limited to possessing or containing only those elements. Likewise, a method that “comprises,” “has,” or “includes” one or more steps possesses those one or more steps, but is not limited to possessing only those one or more steps.

Any embodiment of any of the apparatuses, systems, and methods can consist of or consist essentially of—rather than comprise/include/have—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb.

Further, a device or system that is configured in a certain way is configured in at least that way, but it can also be configured in other ways than those specifically described.

In this respect, before explaining at least one embodiment in detail, it is to be understood that the embodiments are not limited in application to the details of construction and to the arrangements of the components set forth in the following description or illustrated in the drawings. Also, it is to be understood that the phraseology and terminology employed herein are for the purpose of description and should not be regarded as limiting.

Many further features and combinations thereof concerning embodiments described herein will appear to those skilled in the art following a reading of the present disclosure.

### DESCRIPTION OF THE FIGURES

In the figures, embodiments are illustrated by way of example. It is to be expressly understood that the description and figures are only for the purpose of illustration and as an aid to understanding.

Embodiments will now be described, by way of example only, with reference to the attached figures, wherein in the figures:

FIG. 1 is a cutaway, perspective view of a mixing assembly received within a container, in accordance with an embodiment of the present disclosure;

FIG. 2A is a cross-sectional elevation view of the mixing assembly within the container of FIG. 1;

FIG. 2B is an enlarged cross-sectional view of a portion of the mixing assembly of FIG. 2A;

FIG. 3A is an elevation view of the alignment assembly illustrated in FIG. 2A;

FIG. 3B is an elevation view of an alignment shaft, in accordance with an embodiment of the present disclosure;

FIG. 4A is a top view of a mixing assembly, in accordance with an embodiment of the present disclosure;

FIG. 4B is a perspective view of a paddle assembly, in accordance with an embodiment of the present disclosure;

FIG. 5A is a side elevation view of a paddle assembly, in accordance with an embodiment of the present disclosure;

FIG. 5B is a cross-sectional elevation view of the paddle assembly of FIG. 5A;

FIG. 6A is a top view of an annular brush, in accordance with an embodiment of the present disclosure;

FIG. 6B is an enlarged view of a portion of the annular brush of FIG. 6A;

FIG. 7 illustrates a partial, cross-sectional view of the mixing assembly within a container, in accordance with an embodiment of the present disclosure;

FIG. 8 illustrates an enlarged, perspective view of the alignment assembly illustrated in FIG. 7;

FIG. 9 illustrates an enlarged perspective view of an alignment assembly, in accordance with another embodiment of the present disclosure;

FIG. 10 illustrates a partial, enlarged perspective view of an elongate hollow section and a container, in accordance with embodiments of the present disclosure;

FIG. 11 illustrates positioning of a shaft associated with an external drive device for engaging with a coupling end of an elongate hollow section of a mixing assembly, in accordance with embodiments of the present disclosure;

FIG. 12 illustrates a partial, cross-sectional view of an elongate hollow section and a container, in accordance with embodiments of the present disclosure;

FIG. 13 illustrates positioning of a socket-shaped shaft end associated with an external drive device for engaging with a coupling end of an elongate hollow section of a mixing assembly, in accordance with embodiments of the present disclosure; and

FIG. 14 illustrates a method of mixing contents within a container, in accordance with embodiments of the present disclosure.

### DETAILED DESCRIPTION

Hazardous waste materials may include nuclear waste, among other types of waste. The waste materials may be mixed with immobilization reagents or cementitious material to immobilize the hazardous constituents. Such a mixture may provide a relatively more stable or solid waste form, reducing the likelihood that such waste materials leak or leach into the environment. In some embodiments, the hazardous constituents may include radioactive liquid waste, intermediate level liquid waste (ILLW), or other types of materials.

In some examples, waste materials and cementitious materials may be mixed in a container, such as a 55-gallon drum or other container types, using an in-drum mixing paddle rotatable by an external drive apparatus. In some examples, the container may include a specialized drum lid. The specialized drum lid may include a guide assembly coupled to a mixing shaft having two or more blades extending into the container. The external drive apparatus may be coupled to the guide assembly of the container when rotation of the mixing shaft is required. As described in the present disclosure, it may not be desirable to utilize specialized or modified drum lids or specialized modifications to the container.

Containers for receiving waste materials may be subject to regulatory standards. For example, to be approved for transportation on publicly accessible roadways, containers for receiving waste materials may need to comply with certification standards, which may include compliance with drop test requirements, water penetration test requirements, etc. When such containers are subjected to drop tests, water penetration tests, etc., the certification standards may require that the containers not be breached or damaged based on a set of criteria.

As described in the present disclosure, in some examples, containers may be modified to include components directed to stabilizing in-drum mixing paddles or to coupling the in-drum mixing paddles to an external drive apparatus. Such modifications to containers may invalidate prior certification testing associated with regulatory standards. Conducting re-certification testing of modified containers may be a laborious or time-consuming process. Further, modified or new container manufacturing processes may be required to accommodate components directed to stabilizing in-drum mixing paddles. Further, such modified containers may include features that alter compatibility with apparatus or processes that otherwise may be setup to operate with standardized containers. Improved mixing assemblies for adapting to standardized or prior certified containers for receiving waste materials may be desirable.

Embodiments of the present disclosure may provide mixing assemblies for positioning within stock or readily available containers for containing hazardous waste materials. Embodiments of the present disclosure provide alignment assemblies that may be adaptable to numerous container geometries or dimensions for providing support to paddle assemblies within containers without structural features modifying the external structural features or integrity of the containers. As external features or structural integrity of the containers need not be altered, re-certification testing based on regulatory standards of containers for waste transportation, disposal, etc. may not be required.

Embodiments of the present disclosure may provide mixing assemblies that may mix immobilization reagents with waste materials in situ within containers (e.g., 55-gallon drums, etc.) while reducing occurrences of waste materials and/or immobilization reagents splashing outside the containers. In some examples, annular brushes or annular structures may be coupled to mixing assemblies and positioned proximal to an opening of the containers for reducing occurrences of waste materials splashing outside the containers.

Embodiments of the present disclosure may provide mixing assemblies including alignment assemblies that may be positioned adjacent to a base of a container and may be configured to support rotation of paddle assemblies within the container for mixing waste material or immobilization reagents. In some examples, rotation of the paddle assemblies may be concentric with a centroid of the base of the container.

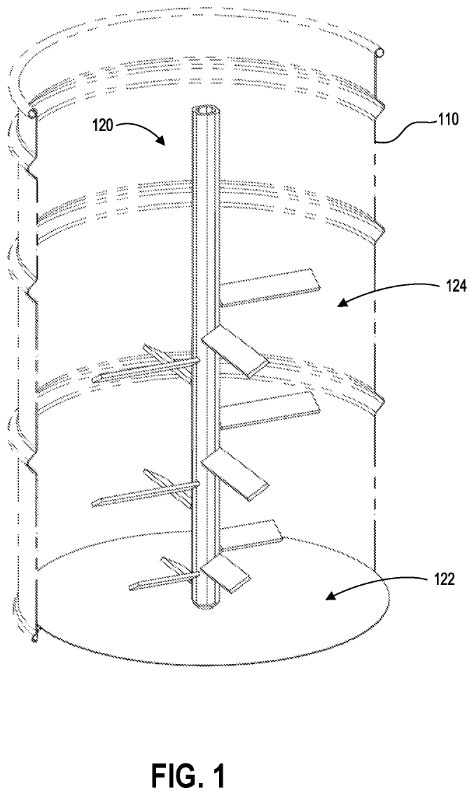

Reference is made to FIG. 1, which illustrates a cutaway, perspective view of a mixing assembly 120 received within a container 110, in accordance with an embodiment of the present disclosure.

The container 110 may be a substantially cylindrical drum having a circular base. For example, the container 110 may be a 55-gallon drum for receiving waste materials. In some embodiments, the container 110 may include other geometric shapes or volumes to provide a contained volume for receiving waste materials. For example, the container 110 may be a cuboid (e.g., rectangular prism, etc.), or a container having any other shape or configuration. In some embodiments, the container 110 may be constructed of carbon steel, stainless steel, or other materials suitable for containing materials (e.g., waste materials).

The mixing assembly 120 may include an alignment assembly 122 and a paddle assembly 124. The paddle assembly 124 may be engaged with the alignment assembly 122. The alignment assembly 122 may be received or positioned within a base of the container 110. In some embodiments, the alignment assembly 122 may be positioned or mounted adjacent the base of the container 110 without modification to the container 110. When received within the container 110, the mixing assembly 120 may be substantially contained within the confines of the container 110 and a standardized lid may be used for sealing the container 110.

In some situations, when waste materials and the mixing assembly 120 are received within the container 110, an external drive apparatus (not illustrated in FIG. 1) may be removably coupled to the mixing assembly 120. In some embodiments, the external drive apparatus may be positioned at a location that may be physically remote to the container 110. For example, the external drive apparatus may be located at a distance from the container 110 such that an operator of the external drive apparatus may be physically distant from the container 110. By being physically distant from the container 110, the likelihood that waste or other materials from the container 110 becoming into contact with the operator may be reduced.

In some embodiments, a shaft may couple the external drive apparatus to the mixing assembly 120, and the external drive apparatus may be configured to provide rotational movement to the mixing assembly 120 for mixing contents within the container 110. In some embodiments, the mixing assembly 120 may include features to couple, via the shaft, to the external drive apparatus when rotational energy is required for mixing contents within the container 110. In some embodiments, upon completion of operations for mixing contents within the container 110, the mixing assembly 120 may include features to decouple from the external drive apparatus.

The external drive apparatus may rotate the mixing assembly 120 to mix the waste material with an immobilization reagent. In some embodiments, the immobilization reagent may include cementitious material, or other materials, for immobilizing wastes. Once mixing of the waste material and the immobilization reagent is complete, the external drive apparatus may be de-coupled from the mixing assembly 120 and a standardized lid may be used to seal the container 110 for transport, waste storage, etc. In some situations, at least one of the alignment assembly 122 or the paddle assembly 124 may transported or disposed of in combination with the waste material.

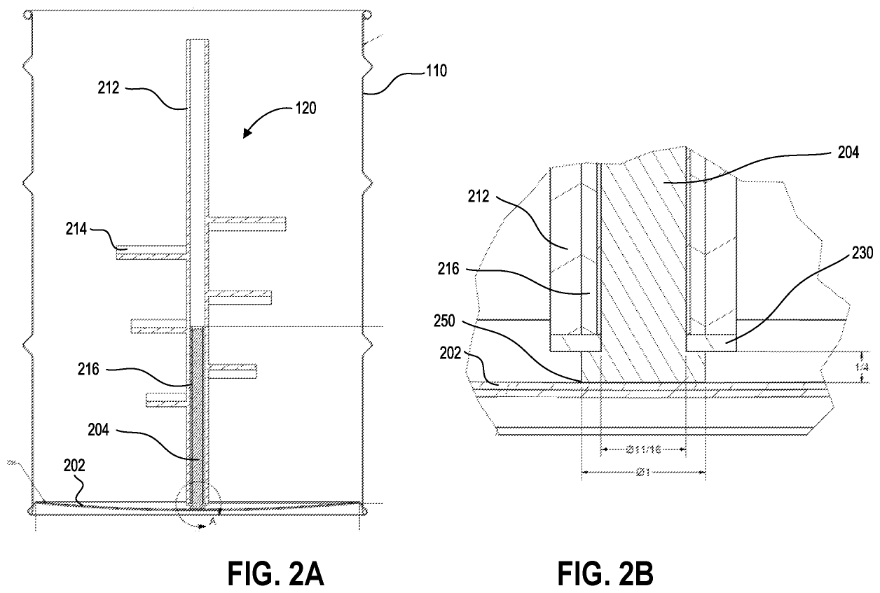

Reference is made to FIG. 2A, which illustrates a cross-sectional view of the mixing assembly 120 within the container 110. As described in the present disclosure, the mixing assembly 120 includes the alignment assembly 122 (FIG. 1) and the paddle assembly 124 (FIG. 1).

The alignment assembly 122 may include an alignment dish 202 having a dish surface with a geometric shape substantially similar to the base of the container 110. For example, the container 110 may be a cylindrical drum and the base of the container 110 may be circular. In the present example, the alignment dish 202 may be circular having similar or smaller diameter than the circular base of the container 110. The alignment dish 202 may be configured to include a geometrically similar shape as the base of the container 110 such that the alignment dish 202 may fit concentrically adjacent to the base of the container 110.

In some embodiments, the alignment dish 202 may be configured to have a geometric shape that may be not be substantially similar to the base of the container 110. As a non-limiting example, the alignment dish 202 may be configured as a triangular shape, and the alignment dish 202 may have a centroid substantially aligned with a center point of the circular base of the container 110. In some embodiments, the alignment dish 202 having the triangular shape may be dimensionally sized such that the vertex may engage with a circumferential edge of the circular base of the container 110. In some other embodiments, the alignment dish 202 may be a polygon having a perimeter that may be less than the circumference of the circular base of the container 110. Other geometric configurations of the alignment dish 202 may be contemplated.

The alignment assembly 122 may include an alignment shaft 204 projecting from the dish surface. In some examples, the alignment shaft 204 may project in a direction substantially perpendicular to the dish surface or alignment dish 202. As will be illustrated in the present disclosure, the alignment shaft 204 may have a shaft length such that the paddle assembly may be supported and aligned with an external drive apparatus without any additional supporting features proximal to an opening of the container 110.

The paddle assembly 124 may engage with the alignment shaft 204. The paddle assembly 124 may include an elongate section for engaging with the alignment shaft 204. In some embodiments, the elongate section for engaging with the alignment shaft 204 may be an elongate hollow section for receiving the alignment shaft 204. In some other embodiments, the alignment shaft 204 may be a hollow shaft configured to receive the elongate section, such that the elongate section engages with the alignment shaft 204.

In FIG. 2A, the elongate hollow section 212 may have a hollow length greater than an alignment shaft length of the alignment shaft 204. That is, the shaft length may be configured to support the paddle assembly 124 within the container 110 and without requiring any additional upper guide features proximal to the opening of the container.

In some embodiments, the alignment shaft 204 may include mechanisms or materials for reducing rotational friction when the paddle assembly 124 is rotated while engaged with the alignment shaft 204. For example, such mechanisms or materials for reducing rotational friction may include bearings or a structure including bearings. In some situations, it may be beneficial to reduce rotational friction about the alignment shaft 204 to reduce required torque to be expended (e.g., by an external drive apparatus) to the paddle assembly 124, and to increase contents mixing performance or mixing speed for a given expended torque for rotating the paddle assembly 124.

As an illustrating example, the shaft length of the alignment shaft 204 may be approximately ⅓ of the height of the container 110, such that the paddle assembly 124 may be supported in an upstanding orientation without requiring further support features proximal to the opening of the container 110. In the situation when an external drive apparatus is coupled to the paddle assembly 124 (e.g., via an end portion of the elongate hollow section 212), the end portion of the elongate hollow section 212 nearest to the opening of the container 110 may be supported by the external drive apparatus coupled thereto. In some other embodiments, the shaft length of the alignment shaft 204 may be other lengths different than ⅓ of the height of the container 110.

The paddle assembly 124 may include a plurality of blades 214 projecting from the elongate hollow section 212 for mixing contents contained within the container 110. The plurality of blades may be distributed along the length of the elongate hollow section 212.

In some embodiments, the plurality of blades may be a series of angled, flat stirrer blades. In some examples, the geometric shape, height, and number of blades may be configured based on the physical properties of anticipated waste material and/or immobilization reagent that may be placed within the container 110. For example, a first configuration of geometric shape, height, and number of blades required for mixing a dense waste material may be different than a second configuration of geometric shape, height, and number of blades required for mixing a less dense waste material. In some embodiments, the arrangement, dimension, and/or number of blades provided about the hollow elongate section 212 may be based on the chemical composition or rheology of the anticipated waste material and/or immobilization reagent received within the container.

In some embodiments, the elongate hollow section 212 may be constructed from a steel square hollow section. In some embodiments, the elongate hollow section 212 may be constructed of other materials and may be a hollow section having other geometric configurations, such as a cylindrical hollow section or a triangular hollow section.

The embodiments described in the present disclosure may allow at least one of the alignment assembly 122 or the paddle assembly 124 to be transported or disposed of in combination with the waste material and immobilization reagent, such that the container 110 is not altered and does not require any re-certification testing to ensure compliance with regulatory standards. Further, embodiments described in the present disclosure may provide alignment assemblies 122 configured to be positioned within dimensions of existing stock or existing commercial containers without any required modification of the stock or commercial containers. That is, embodiments described in the present disclosure provide alignment assemblies or paddle assemblies that may be: (1) adaptable to containers and remain in the container following waste immobilization; or (2) driven by an external drive apparatus and decoupled from the external drive apparatus upon the waste being immobilized.

Reference is made to FIG. 2B, which illustrates an enlarged cross-sectional view of a portion of the mixing assembly of FIG. 2A. In FIG. 2B, the elongate hollow section 212 may include a sleeve 216. The sleeve 216 may be positioned within the elongate hollow section 212 such that the sleeve 216 may be positioned between at least a portion of the elongate hollow section 212 and the alignment shaft 204. In some embodiments, the sleeve 216 may include polytetrafluoroethylene (PTFE) tubing that may have a smooth surface finish and a low coefficient of friction and lubricity. In some embodiments, the sleeve 216 may be constructed of other materials to provide a low friction bearing when the paddle assembly 124 is coupled to the alignment assembly 122 and when the paddle assembly 124 is rotated about the alignment shaft 204. The sleeve 216 may be configured to facilitate rotation of the paddle assembly 124 about the alignment shaft 204. Dimensions illustrated in FIG. 2B are illustrating examples only. Other dimensions may be contemplated.

Referring still to FIG. 2B, in some embodiments, the mixing assembly may include a spacer component 230 that may be threaded or looped around the alignment shaft 204. When the spacer component 230 is positioned around the alignment shaft 204 and when the alignment shaft 204 is received within the elongate hollow section 212, the spacer component 230 may be positioned between an end portion of the elongate hollow section 212 and the alignment dish 202. The spacer component 230 may provide a low friction, vertical thrust bearing surface for the elongate section 212. In some embodiments, the spacer component 230 may be a plastic washer. In some embodiments, the spacer component 230 may be constructed using other materials.

In some embodiments, the alignment shaft 204 may be coupled to the alignment dish 202 based on tack welds 250 or seal welds. Other methods of coupling the alignment dish 202 to the alignment shaft 204 may be contemplated.

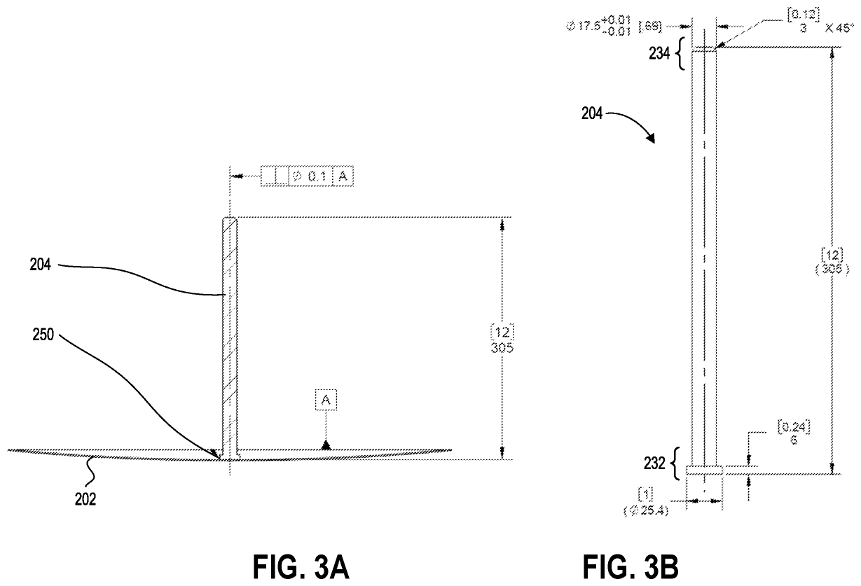

Reference is made to FIG. 3A, which illustrates an elevation view of the alignment assembly of FIG. 2A. The alignment assembly includes the alignment dish 202 and the alignment shaft 204 projecting or configured in an upstanding position from a surface of the alignment dish 202. In some embodiments, the alignment shaft 204 may be coupled to the alignment dish 202 based on tack welds 250, seal welds, or other coupling structures.

In the embodiment illustrated in FIG. 3A, the alignment dish 202 may be configured to have a convex surface on which the alignment shaft 204 may be coupled. In some other embodiments, the alignment dish 202 may be configured to have a concave surface on which the alignment shaft 204 may be coupled. In some embodiments, when the paddle assembly is coupled to the alignment shaft 204, alignment dish 202 may be dimensioned for positioning the paddle assembly substantially centrally within the container 110. That is, the paddle assembly may be positioned at a centroid of the surface of the alignment dish 202. For example, when the surface of the alignment dish 202 is circular, the paddle assembly may be coupled to the projecting alignment shaft 204 at a center of the circular alignment dish 202.

In some embodiments, in combination with rotation of a mixing assembly 120 (FIG. 2A) within the container 110, the alignment dish 202 may include structures configured to promote or increase turbulence among contents of the container 110. For example, the alignment dish 202 may include one or more projections extending form the alignment dish 202 into the volume. For example, projections may include veins or fins, or other example structures extending from the alignment dish 202 into the volume within the container 110. In combination with rotation of example mixing assemblies, the projections (e.g. veins or fins) may promote increased mixing efficiency. In some scenarios, the shape or size of the veins or fins may be configured based upon properties of contents to be mixed within the container 110. Such contents properties may include viscosity of the fluid or the immobilization reagent, among other properties. Examples of veins or fins coupled to the alignment dish 202 will be disclosed in subsequent drawings.

In some embodiments, the alignment dish 202 may be manufactured or customized for the container 110 by trimming a base obtained from a similarly dimensioned container, such that the alignment dish 202 may be positioned to have close fitment with the base of the container 110. As the alignment dish 202 may be dimensioned to closely match the base of the container 110, in situations when the paddle assembly is rotated about the alignment shaft 204 for mixing the waste received within the container, the alignment shaft 204 may not rotate due at least to fictional forces between surfaces of the alignment shaft 204 and the base of the container.

Reference is made to FIG. 3B, which illustrates an elevation view of the alignment shaft 204 of FIG. 3A. In some embodiments, the alignment shaft 204 may include a tapered end 234 or chamfered portions at a first end of the alignment shaft 204. When the elongate hollow section 212 (FIG. 2A) may be brought proximal to the alignment shaft 204, the tapered end 234 may assist receipt of the alignment shaft 204 within the elongate hollow section 212 as the elongate hollow section 212 is placed atop the alignment shaft 204. Dimensions illustrated in FIG. 3B are illustrating examples only. Other dimensions associated with the alignment shaft 204 may be contemplated.

A second end of the alignment shaft 204 may be coupled to the alignment dish 202 via an alignment base 232. The alignment base 232 have a cross-sectional diameter greater than a cross-sectional diameter of the alignment shaft 204. In some embodiments, the spacer component 230 (FIG. 2B) may be threaded or looped around the alignment shaft 204 and may be positioned atop the alignment base 232. When the paddle assembly receives the alignment shaft 204, the spacer component 230 may be positioned between the alignment base 232 and the elongate hollow section 212 of the paddle assembly.

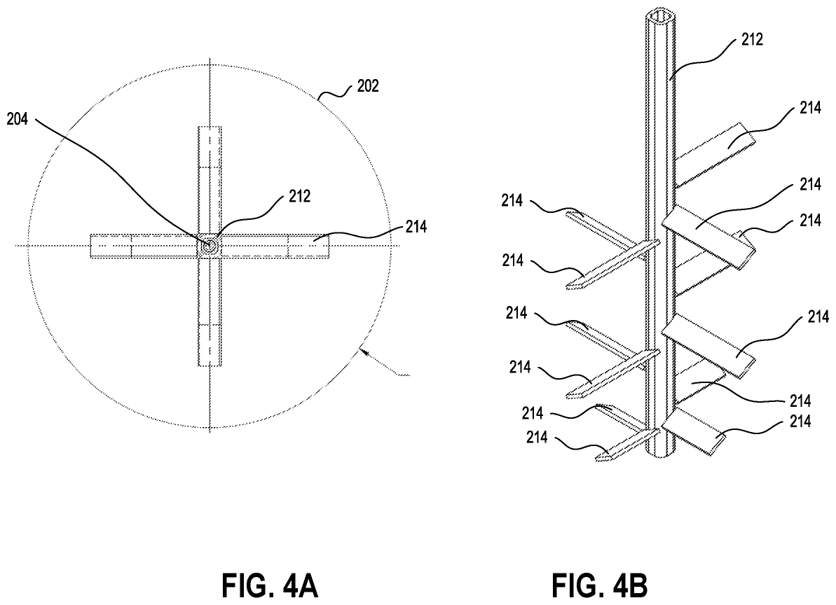

Reference is made to FIG. 4A, which illustrates a top view of the mixing assembly illustrated in FIG. 2A. In FIG. 4A, the alignment dish 202 may be a circular and the alignment shaft 204 may project from a center point of the alignment dish 202. The circular alignment dish 202 in FIG. 4A is exemplary and, in some embodiments, the alignment dish 202 may be configured as other geometric shapes. That is, the alignment dish 202 may be rectilinear, oval, triangular, or other shapes.

As described in the present disclosure, the paddle assembly may include a hollow elongate section 212 and a plurality of blades projecting from the elongate hollow section 212. In the embodiment illustrated in FIG. 4A, the plurality of blades may be distributed along the length of the elongate hollow section 212 (e.g., distributed in a direction into or out of the page of FIG. 4A) and may be distributed at substantially right angles to one another about the elongate hollow section 212. In FIG. 4A, from a top view, the respective blades are positioned at substantially 90 degrees from another blade in an annular direction. In some other embodiments, the respective blades may be positioned at any other number of degrees from another blade in the annular direction.

Reference is made to FIG. 4B, which illustrates a perspective view of the paddle assembly illustrated in FIG. 2A. The paddle assembly includes the elongate hollow section 212 and a plurality of blades 214 projecting from the elongate hollow section for mixing contents contained within a container. In FIG. 4B, the elongate hollow section 212 may be a substantially hollow section including a generally square or rectangular cross section. Hollow sections having other geometric shapes may be contemplated, including circular or elliptical cross sections.

The paddle assembly may be coupled to an example alignment assembly described in the present disclosure, and the elongate hollow section 212 may be positioned substantially orthogonal to an alignment dish positioned adjacent a base of the container. In some embodiments, the respective blades may be angled relative to a plane the alignment dish and/or the base of the container. For example, the respective blades may be angled from 0 to 90 degrees relative to the plane of the base of the container. In some embodiments, the plurality of blades 214 may be angled by a substantially similar number of angular degrees. In some embodiments, each of the plurality of blades 214 may be angled a different number of angular degrees relative to another blade in the plurality of blades 214.

In some embodiments, the plurality of blades 214 may be arranged about the elongate hollow section 212 based on properties of the fluid or immobilizing reagent anticipated to be mixed within the container. In some embodiments, the plurality of blades 214 may include additional or fewer blades based on properties of the fluid or immobilizing reagent anticipated to be mixed within the container. In some embodiments, the plurality of blades 214 may include one or more shapes based on properties of the fluid or immobilizing reagent anticipated to be mixed within the container. The arrangement, size, orientation, angular position, or other properties of the plurality of blades relative to the elongate hollow section 212 may be configured or tuned for improving mixing efficiency within the container. For example, the plurality of blades 214 may be configured about the elongate hollow section 212 in a first configuration when a high viscosity fluid is mixed within the container, and the first configuration may be different than a second configuration of a plurality of blades about the elongate hollow section 212 when a low viscosity fluid is mixed within the container.

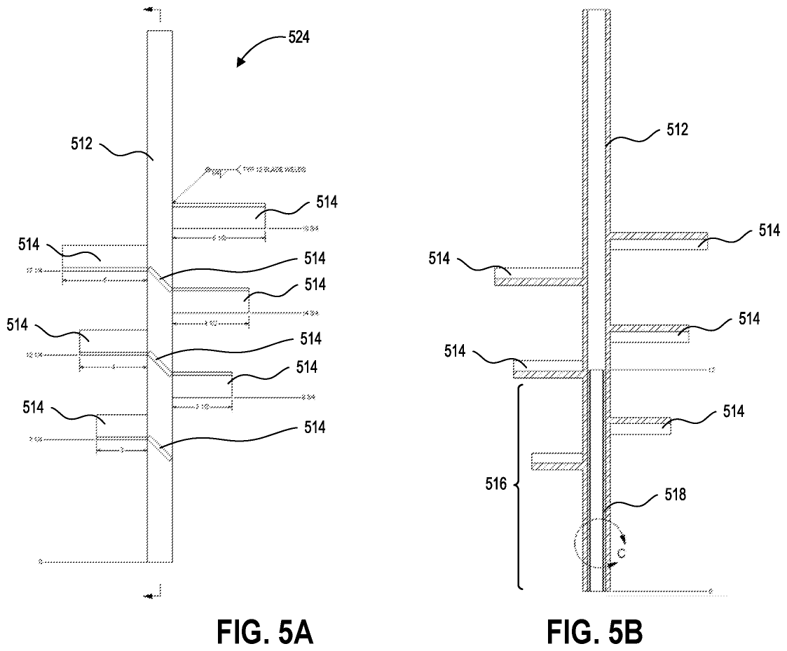

Reference is made to FIG. 5A, which illustrates a side elevation view of a paddle assembly 524, in accordance with an embodiment of the present disclosure. The paddle assembly includes a elongate section 512 and a plurality of blades 514 projecting from the elongate section 512. In some embodiments, the elongate section 512 may include a portion that may be substantially hollow and a portion that may not be substantially hollow. For example, an end of the elongate section 512 configured to receive an alignment shaft described in the present disclosure may include a first length of substantially hollow section for receiving the alignment shaft and a second length that may be of a non-hollow section.

In some embodiments, the plurality of blades 514 may be welded to the elongate section 512. In some other embodiments, elongate section 512 and the plurality of blades 514 may be manufactured as a unitary piece construction. In some embodiments, the paddle assembly 524 may be constructed of a combination of unitary elongate section and blade components and welded components.

In FIG. 5A, one or more of the plurality of blades 514 may be coupled to the elongate section 512 in an angled position relative to a plane of the alignment dish 502 or a base of a container. As an illustrating example, a blade identified with reference numeral 516 may be angled at substantially 45 degrees relative to the plane of the alignment dish 502.

In some embodiments, each of the plurality of blades 514 may be coupled to the elongate section 512 at an angle relative to the plane of the alignment dish 502 that is different than an angle relative to the plane of the alignment dish 502 of another blade of the plurality of blades 514 (not illustrated in FIG. 5A).

Dimensions illustrated in FIG. 5A are illustrating examples only. Other dimensions may be contemplated.

Reference is made to FIG. 5B, which illustrates a cross-sectional elevation view of the paddle assembly 524 of FIG. 5A. In FIG. 5B, the elongate section 512 may include a portion that may be a substantially hollow section 516, and the elongate section 512 may include a sleeve 518 positioned within the substantially hollow section 516. The sleeve 518 may be configured to facilitate rotation of the paddle assembly 524 about an alignment shaft when the alignment shaft is received within the substantially hollow section 516. In some embodiments, the sleeve 518 may be polytetrafluoroethylene (PTFE) tubing having a smooth surface finish coupled with a low coefficient of friction and lubricity. In some embodiments, the sleeve 518 may be constructed of other materials to provide a low friction bearing when an alignment shaft is received within the hollow section 516 and the paddle assembly 524 may be rotated about the alignment shaft.

In some embodiments, the hollow section 516 and the sleeve 518 may be substantially similar length. In an illustrating example, the hollow section 516 may be approximately ⅓ of the height of the overall elongate section 512 or height of the overall container within which the paddle assembly 524 is received. In some embodiments, the elongate section 512 may include the hollow section 516 and a non-hollow section (e.g., portions of the elongate section 512 that may not be configured to receive an alignment shaft).

The elongate section 512 may include a first end proximal to the hollow section 516 that may receive the alignment shaft and a second end proximal to an opening of the container (when the paddle assembly 524 is positioned within the container). In some embodiments, the second end of the elongate section 512 may be configured to couple to an annular brush. When installed, the annular brush may be positioned proximal to an opening of the container to contain splashing of waste material or immobilization reagents while the paddle assembly 524 may be rotated about the alignment shaft. In some embodiments, the annular brush may remain within the container upon mixing of the waste material and immobilization reagent and, subsequently, transported or disposed of alongside the immobilized waste material.

In some embodiments, the annular brush may be an annular plastic brush, an annular wire brush, or an annular brush constructed of other materials to prevent splashing of waste material or immobilization reagents exterior to the container, thereby reducing dissemination of hazardous waste exterior to the container. In some embodiments, the annular brush may be malleable or deformable allowing external nozzles or conduits to be introduced into the container for inserting immobilization reagents with the waste material contained within the container.

Embodiments of mixing assemblies of the present disclosure may be positioned within a container based on one or more of the following operations: (1) removing a lid or lid retaining structure (e.g., clamp ring) from the container; (2) position an alignment dish, including an alignment shaft projecting from the alignment dish, within base of the container; (3) position spacer component at the base of the alignment shaft; (4) position a paddle assembly within the container such that the paddle assembly may couple with the alignment shaft; (5) position an annular brush to couple with the paddle assembly, such that the annular brush is proximal to the opening of the container; or (6) position the lid onto the container and secure the lid using the lid retaining structure.

Embodiments of mixing assemblies described in the present disclosure may be configured to immobilize waste materials within a container, such that the contained waste may be transported, stored, disposed of, etc. As an illustrating example, operations for immobilizing waste materials within a container may include one or more of the following operations: (1) with a container lid loosened or the container on a container lifting device, remove the container lid using a container lid tool or apparatus, including rotating the container lid away from the container opening; (2) initialize an external drive apparatus; (3) raise the container to a container filling station to couple the external drive apparatus with the paddle assembly positioned within the container; (4) fill the container based on sub-operations, including: metering a volume of waste material; stirring the waste material using the paddle assembly; metering liquid and solid solidification reagent for placement in the container for producing a homogenous mixture; removing displaced air via an active ventilation system and maintaining container space at a suitable “depression level” to reduce occurrence of waste material escaping the container to the external environment; (5) lowering the container away from the filling station; (6) positioning the container to the lid apparatus or tool for positioning the container lid proximal to the opening of the container; or (7) securing the container lid on the container by a lid retaining structure (e.g., clamp ring, etc.).

In the above examples, in the scenario when the external drive apparatus may malfunction or may not properly couple to the mixing assembly within the container, operations may decouple the external drive apparatus and a lid may be placed at the opening of the container to seal the container while a technician may troubleshoot the malfunction associated with the external drive apparatus. In some situations, once the external drive apparatus may be repaired, the external drive apparatus may be re-coupled to the mixing assembly for continued mixing operations. Being able to de-couple an external drive apparatus from a mixing assembly contained within the container may reduce occurrences of waste materials being splashed out of the container or may reduce occurrences of waste materials being introduced to the environment external to the container.

In some embodiments, the mixing assembly is modular and may be positioned within a container without being fixed to the container. Accordingly, a standard or readily available container may be retrofitted with example mixing assemblies described in the present application. In some embodiments, the mixing assemblies may be sacrificial. That is, the mixing assemblies may be disposed of within the container, thereby reducing the chance that hazardous waste materials exit the container when troubleshooting problems associated with coupling the mixing assembly with an external driving apparatus.

In some embodiments, a method of mixing contents within a container may include: positioning a mixing assembly within the container, the mixing assembly including a paddle assembly, wherein the paddle assembly includes an elongate hollow section for receiving an alignment shaft positioned within the container and projecting from an alignment dish positioned in a base of the container, the elongate hollow section having a hollow length greater than an alignment shaft length of the alignment shaft; coupling an external drive apparatus to the mixing assembly via the elongate hollow section; and rotating, via the external drive apparatus, the mixing assembly within the container. In some embodiments, the method includes inserting, into the container, an immobilization reagent for mixing with the contents within the container. In some embodiments, positioning the mixing assembly within the container includes positioning the alignment dish within the base of the container such that the alignment shaft is positioned at a centroid of the base of the container, and where rotating the mixing assembly within the container includes rotating the paddle assembly concentric with the base of the container.

In some embodiments, the method of mixing contents may further include: decoupling the elongate hollow section of the external drive apparatus; and securing a lid to the opening of the container to contain the mixing assembly and the mixed substance within the container.

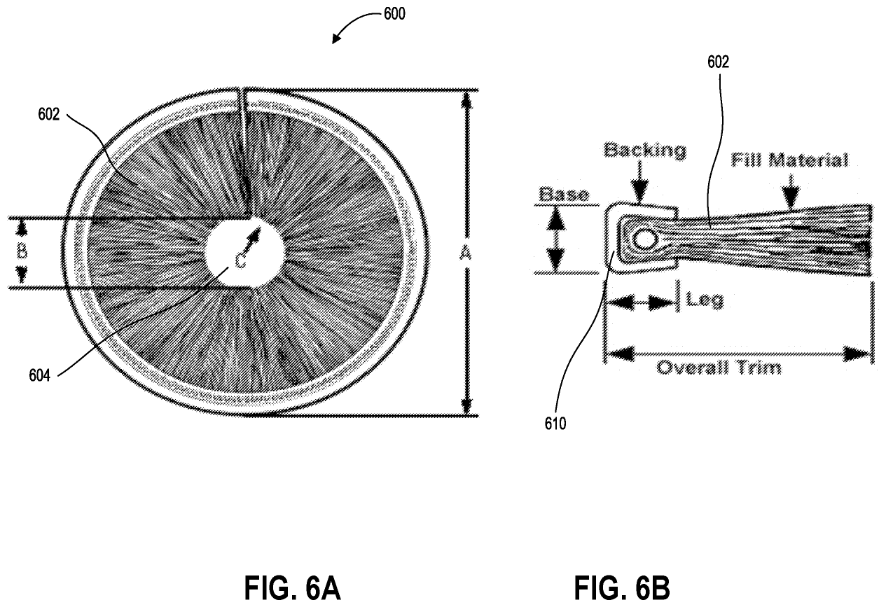

Reference is made to FIG. 6A, which illustrates a top view of an annular brush 600, in accordance with an embodiment of the present disclosure. The annular brush 600 may be coupled to a paddle assembly and be positioned proximal to an opening of a container to contain splashing of waste material or immobilization reagents while the paddle assembly may be rotated about an alignment shaft.

In some embodiments, when the paddle assembly is rotated about the alignment shaft (as described in some embodiments of the present disclosure), waste material and an immobilization reagent received within a container may be mixed or blended together. Due to centrifugal force, the contents of the container may be churning, thereby leading to globules or waste product (e.g., waste material and/or immobilization reagents) being rotated within the container. Accordingly, the annular brush 600 may be configured to contain splashing waste material within the container.

The annular brush 600 may include a series of brush components 602 extending radially from a central region 604. The central region 604 may be circular in shape and may have a diameter identified by reference numeral B (in FIG. 6) and a radius identified by reference numeral C (in FIG. 6). The annular brush 600 may have a diameter identified by reference numeral A (in FIG. 6). In some embodiments, the annular brush 600 may have a diameter substantially corresponding to a container diameter of an opening of the container. When the diameter of the annular brush 600 may substantially correspond to the container diameter, the annular brush 600 may prevent splashing of the waste material out of the container.

In some embodiments, the central region 604 may be configured to allow an external drive apparatus to be inserted into the container and/or to couple to a paddle assembly positioned within the container. In some embodiments, the central region 604 may be configured to allow sensors or other instrumentation to be inserted into the container to monitor or identify the volume of material that is within the container. In some embodiments, the central region 604 may be configured to provide an inlet/outlet to receive nozzles for introducing or extracting materials (e.g., waste, water, cement powder, etc.) into or out of the container. Accordingly, embodiments of the annular brush described in the present disclosure may shield components of a system that may be external to the container from globules or other fragments of waste materials being pushed upward or outward in a direction towards the opening of the container.

In some embodiments, the annular brush 600 may be configured as a sprung disk that may be placed within the container and/or coupled with the paddle assembly without modification to the container components. In some embodiments, the annular brush 600 may have a radial spring force to maintain the annular brush 600 in a static position within the container while the paddle assembly is being rotated.

In some embodiments, the annular brush 600 may be positioned within the container and may be coupled to the paddle assembly, without any modifications to the container structure or to any container lids. Because the container structure or the container lids are not modified to accommodate the annular brush 600, there may be no requirement to conduct re-certification testing for compliance with regulatory standards.

As an illustrating example, the annular brush 600 may have the following design specifications:
Inward Disk/Internal Ring Brush: 22.5″ OD×10″ ID× 5/16″ thickness at #7 galvanized steel backing ( 5/16″ base× 5/16″ leg), 0.030″ crimped black Polypropylene filament.
   The above design specification details are an illustrating example, and other design specifications associated with the annular brush 600 may be contemplated.

Reference is made to FIG. 6B, which illustrates an enlarged view of a portion of the annular brush 600 of FIG. 6A. The annular brush 600 may include brush components 602. In some embodiments, the brush components 602 may include a series of filaments or wires. In some embodiments, the brush components 602 may include polypropylene filaments.

In some embodiments, the annular brush 600 may include a backing 610, including a base for binding the brush components 602 into a series of filaments or wires. In some embodiments, the backing 610 may be configured to couple to the paddle assembly positioned within the container.

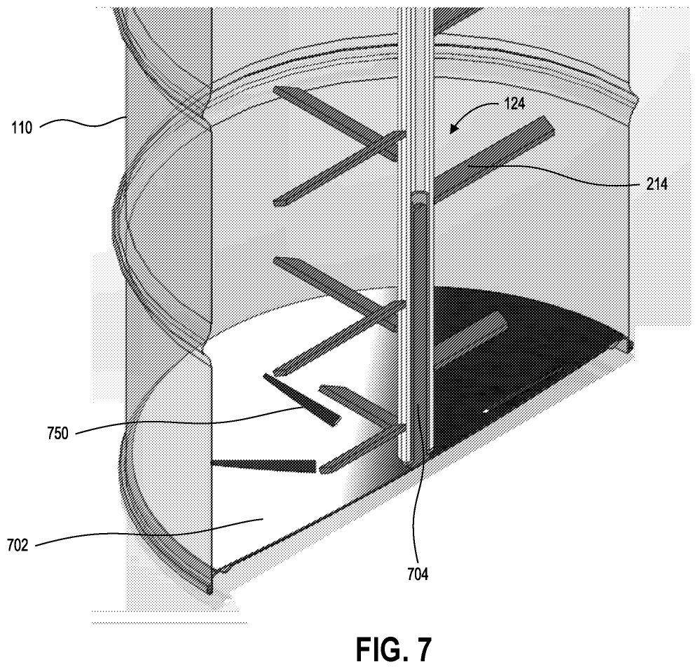

Reference is made to FIG. 7, which illustrates a partial, cross-sectional view of the mixing assembly within a container 110 (FIG. 1), in accordance with another embodiment of the present disclosure. The mixing assembly may include the paddle assembly similar to any one of the paddle assemblies described herein or otherwise (e.g. 124 of FIG. 1) and an alignment assembly.

The alignment assembly may include an alignment dish 702 having a dish surface with a geometric shape substantially similar to the base of the container 110.

The alignment assembly may include an alignment shaft 704 projecting from the dish surface. Similar to the alignment assembly illustrated in FIG. 1, the alignment shaft 704 may project in a direction substantially perpendicular to the dish surface or alignment dish 702.

In some embodiments, the dish surface may be substantially smooth or free of any projections.

In other embodiments, the alignment dish 702 may include one or more projections 750, or other structures, projecting from the alignment dish 702. In combination with rotation of example mixing assemblies, the fins 750 may promote increased mixing efficiency by generating turbulent flow or movement of fluids or immobilization reagents within the container 110 and/or promoting turbulence within the container 110. In the example illustrated in FIG. 7, the one or more fins 750 may be a slat or louver projecting from the surface of the alignment dish 702. The one or more fins 750 may project from the alignment dish 702 at an angle less than 90 degrees relative a surface of the alignment dish 702. In some embodiments, the one or more fins 750 may be rectangular-shaped slats or louvers, may be triangular-shaped slats or louvers, may be trapezoidal slats or louvers, or other example shapes.

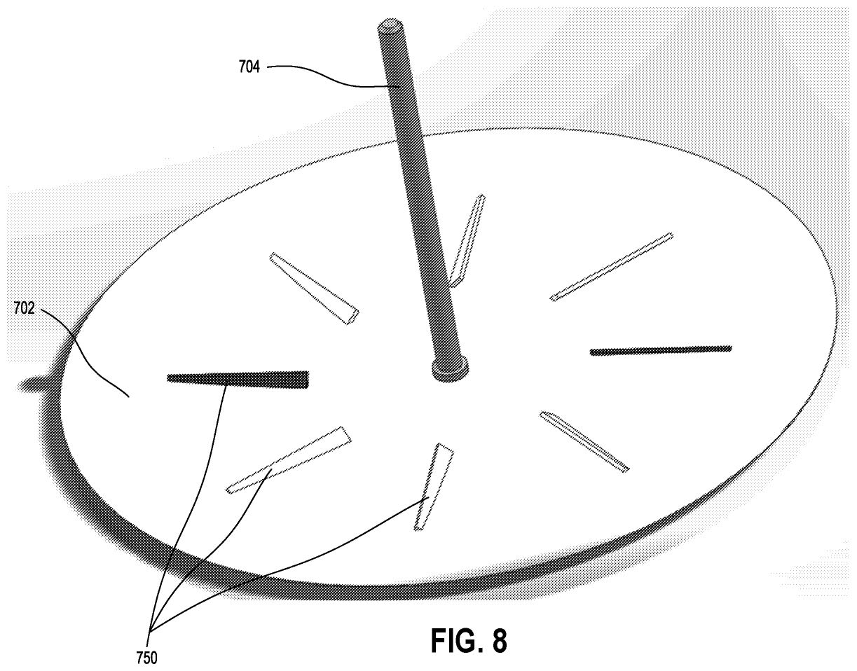

Reference is made to FIG. 8, which illustrates an enlarged, perspective view of the alignment assembly illustrated in FIG. 7. As illustrated, the one or more fins 750 may be slats or louvers projecting from the alignment dish 702. In some embodiments, the one or more fins 750 may be positioned about a central axis of the alignment assembly, or may be positioned in other positions that may be offset from the central axis of the alignment assembly. In some embodiments, the respective fins 750 may be positioned adjacent other fin 750 at a given distance. In some other embodiments, the distance between a respective fin relative to other adjacent fins may be variable.

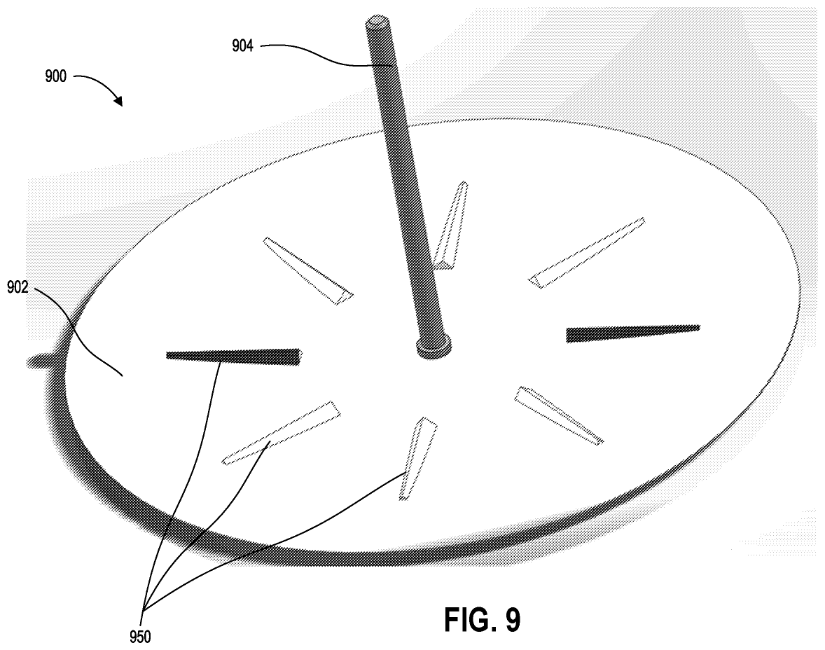

Reference is made to FIG. 9, which illustrates an enlarged perspective view of an alignment assembly 900, in accordance with another embodiment of the present disclosure. The alignment assembly 900 may include an alignment dish 902. The alignment dish 902 may be configured to include a geometrically similar shape as the base of a container in which the alignment assembly 900 is to be inserted. The alignment assembly 900 may include an alignment shaft 904 projecting from a surface of the alignment dish 902.

In some embodiments, the alignment assembly 900 may include one or more fins 950 coupled to or otherwise extending from the alignment dish 902. When a paddle assembly (not illustrated in FIG. 9) is rotated about the alignment shaft 904, the fins 950 may be configured to interrupt movement of fluids or immobilization reagents within the container (not explicitly illustrated) and promoting turbulence within the container, thereby increasing mixing efficiency of fluids and immobilization reagents within the container.

In the illustration of FIG. 9, the one or more fins 950 may be elongate triangular prism structures positioned across the surface of the alignment dish 902. Although triangular prism structures are illustrated in FIG. 9, in some other embodiments, the one or more fins 950 may be any other shaped device for generating turbulent flow or movement of fluids or materials within the container.

As described in the present disclosure, in some scenarios, the paddle assembly may engage with an external drive apparatus, such that the external drive apparatus may impart rotational torque to the mixing paddle assembly for promoting fluid movement within the container. In some embodiments, the paddle assembly may include features for promoting coupling or decoupling the paddle assembly to or from an external drive apparatus.

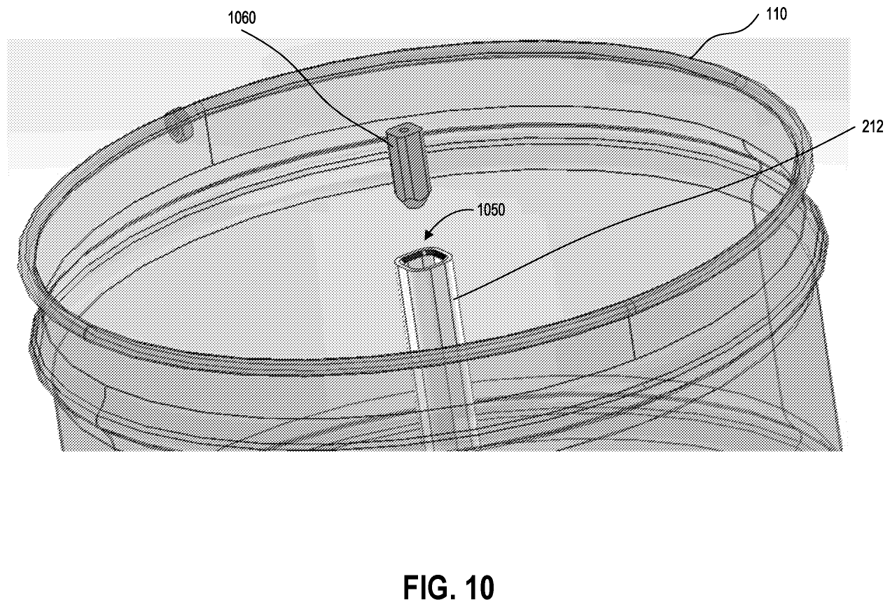

Reference is made to FIG. 10, which illustrates a partial, enlarged perspective view of an elongate hollow section 212 (projecting from an example alignment dish surface, not explicitly illustrated in FIG. 10) and a container 110 having features similar to those shown in FIG. 2A. The elongate hollow section 212 may include a coupling end 1050 proximal to an opening of the container 110. The coupling end 1050 may include a recessed portion configured to receive a shaft 1060 associated with an external drive apparatus. For ease of exposition, a short segment of the shaft 1060 is illustrated in FIG. 10. The shaft 1060 associated with the external drive apparatus may be tapered which may guide the shaft 1060 into an engagement position when it contacts the coupling end 1050 of the elongate hollow section. As the coupling end 1050 may include a recessed portion and as the shaft 1060 may include a tapered end, an operator of the external drive apparatus may more easily couple the shaft 1060 to the elongate hollow section 212 even in scenarios where the shaft 1060 may not be initially aligned with the elongate hollow section 212.

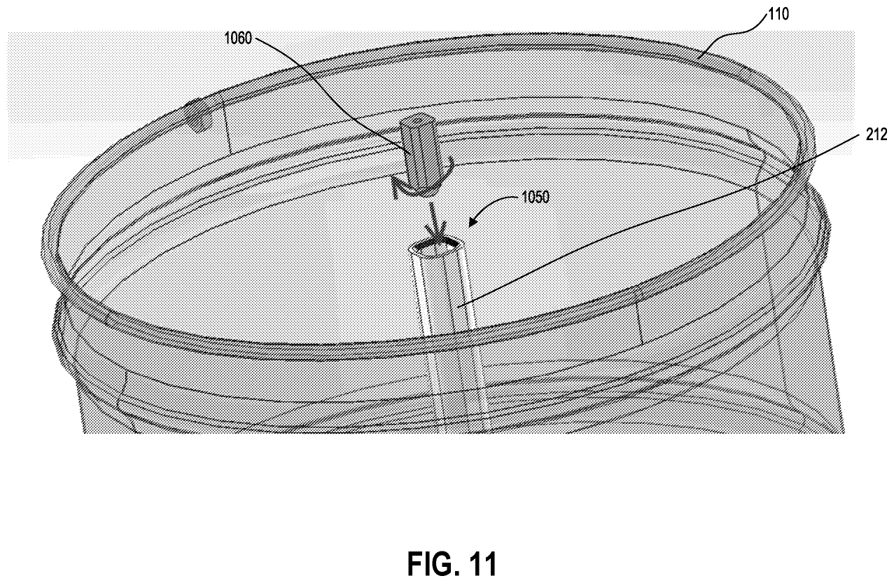

As illustrated in FIG. 11, in scenarios when the shaft 1060 (associated with the external drive apparatus) is received within a portion of the coupling end 1050 of the elongate hollow section 212, the shaft 1060 may be rotated to apply rotational force to the elongate hollow section 212 for rotating the overall paddle assembly (not explicitly illustrated in FIG. 11) within the container 110.

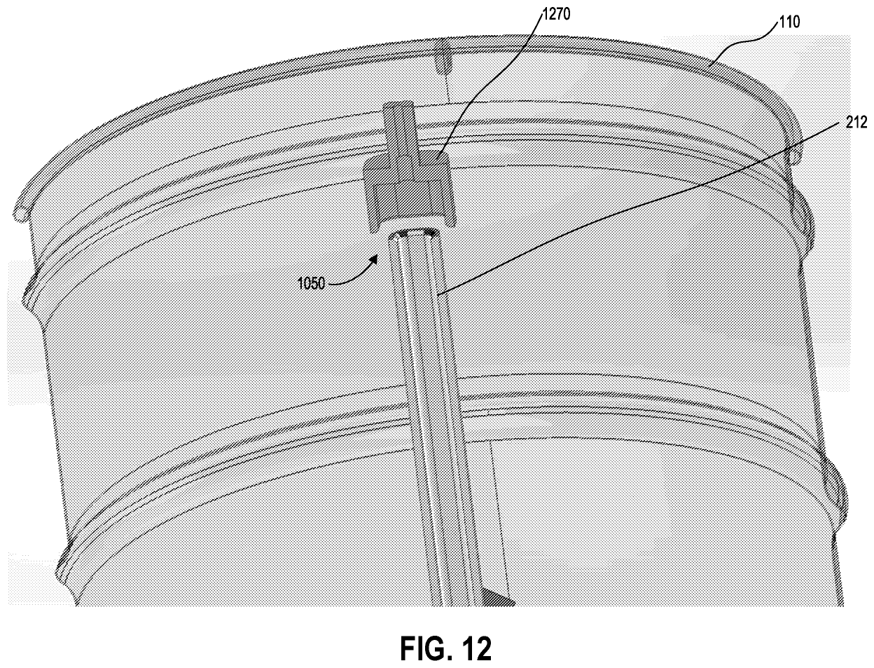

Reference is made to FIG. 12, which illustrates a partial, cross-sectional view of an elongate hollow section 212 (projecting from an example alignment dish surface, not explicitly illustrated in FIG. 12) and a container 110 having features similar to those shown in FIG. 2A. The elongate hollow section 212 may include a coupling end 1050 similar to the coupling end described with reference to FIG. 10.

The coupling end 1050 may be configured to engage with a shaft associated with an external drive apparatus, and the shaft may include a shaft end 1270 sized to envelop, receive, or otherwise engage with the coupling end 1050 when the shaft end 1270 is positioned proximal the coupling end 1050.

In some embodiments, the shaft end 1270 may be shaped akin to a socket, such that when the coupling end 1050 may be received by the shaft end 1270, the external drive apparatus may impart rotational torque for rotating the elongate hollow section 212 to promote mixing of fluids or other materials within the container 110. By configuring the shaft end 1270 akin to a socket configuration, the external drive apparatus may be coupled or decoupled from the elongate hollow section 212 in a relatively seamless operation.

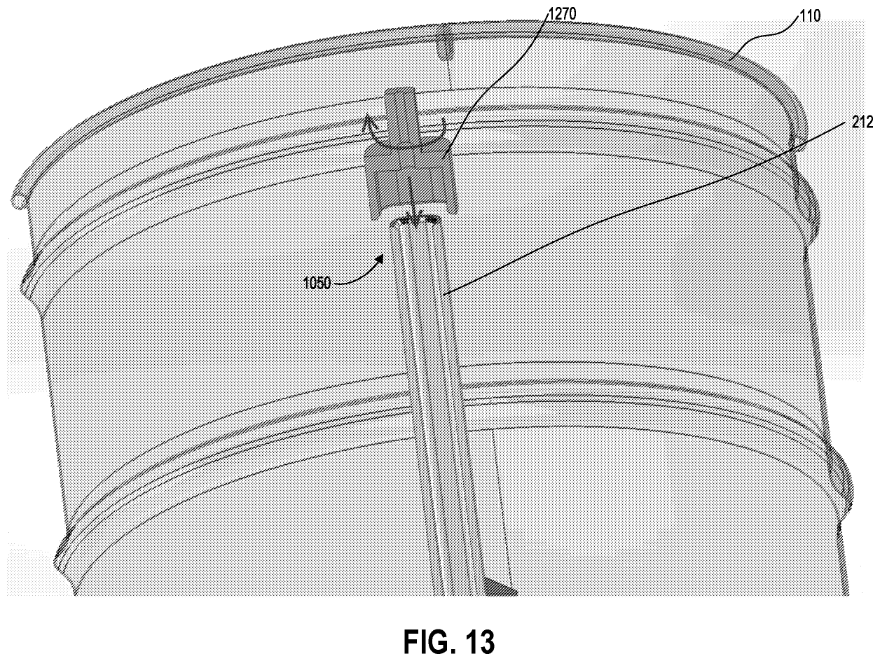

As illustrated in FIG. 13, in scenarios when the shaft end 1270 (associated with the external drive apparatus) receives the coupling end 1050 of the elongate hollow section 212, the shaft end 1270 may be rotated to apply rotational torque to the elongate hollow section 212 for rotating the overall paddle assembly (not explicitly illustrated in FIG. 13) within the container 110.

In other embodiments, different engagement mechanisms for imparting rotational force from the drive shaft 1060 to the shaft of the paddle assembly may be used or provided. For example, in some embodiments, the example engagement mechanisms illustrated on the drive shaft and the paddle assembly shaft may be swapped. In other embodiments, other engagement mechanisms can also be used.

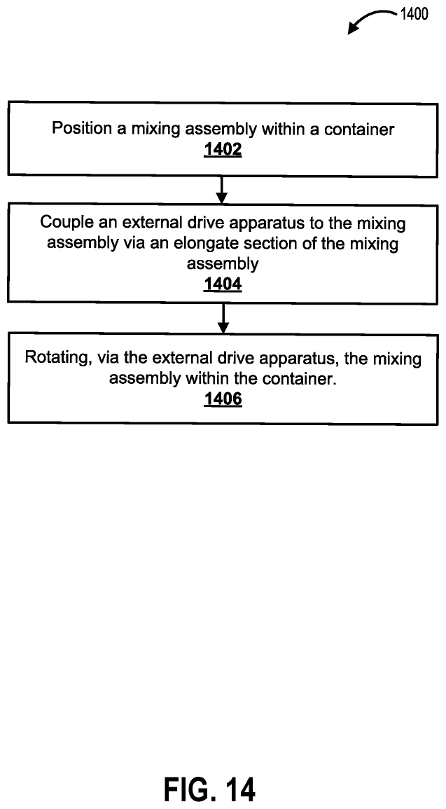

Reference is made to FIG. 14, which illustrates a method 1400 of mixing contents within a container, in accordance with embodiments of the present disclosure. The method 1400 may include operations for operating a mixing assembly positioned within a container.

In some embodiments, the container may be a cylindrical drum container, or may be a container having any other shape or configuration. In some scenarios, containers may require certification for ensuring that such containers may meet regulatory standards for waste (or other material) transportation, disposal, among other example use cases or requirements.

In some scenarios, obtaining regulatory certification associated with containers may be costly or may require a length certification process. In some scenarios, specialized engineering resources may be required for designing containers having features such that subject containers may pass regulatory certification tests. In some situations, designs which add additional elements or structures which are coupled to the drum container may require re-certification of the drum container having the coupled additional elements or structures. It may be beneficial to provide mixing assemblies that may be adapted to previously certified containers based on operations that do not render the prior regulatory certification tests out-of-date.

In some embodiments, a mixing assembly for positioning within a container may include a paddle assembly. The paddle assembly may include an elongate hollow section for receiving an alignment shaft positioned within the container and projecting from an alignment dish positioned in a base of the container. The elongate hollow section may include a hollow length greater than an alignment shaft length of the alignment shaft.

At operation 1402, the mixing assembly may be positioned within a container. In an example, the container may be a cylindrical container and the base may be a circular base. In the present example, the alignment dish of the mixing assembly may have a substantially circular base sized to be positioned in the cylindrical container.

In some embodiments, the alignment dish may be positioned within the base of the container such that the alignment shaft is positioned at a centroid of the base of the container.

At operation 1402, an external drive apparatus may be coupled to the mixing assembly via the elongate hollow section of the paddle assembly.

In some embodiments, the external drive apparatus may include a shaft having a socket-type end for coupling with the elongate hollow section of the paddle assembly, as described in an example with reference to FIGS. 12 and 13. For example, coupling the external drive apparatus to the mixing assembly via the elongate hollow section includes mating a socket-shaped shaft end of the external drive apparatus to a coupling end of the elongate hollow section.

In some embodiments, the external drive apparatus may include a shaft having a shaft end that may be received within a recessed portion of a coupling end of the elongate hollow section of the paddle assembly, as described in an example with reference to FIGS. 10 and 11. In some embodiments, the shaft end may include a tapered tip, such that the shaft end may be received within the recessed portion of the elongate hollow section, even in scenarios where the shaft end may not be substantially spatially aligned with the recessed portion of the elongate hollow section. For example, coupling the external drive apparatus to the mixing assembly via the elongate hollow section includes inserting an external drive apparatus shaft end within a recessed end of the elongate hollow section.

In some above-described embodiments, features of the external drive apparatus or the elongate hollow section may promote relatively easy and remote operation of the external drive apparatus, such that the external drive apparatus may be coupled to the mixing assembly without an operator being in close proximity to the container. In scenarios where the container may contain hazardous waste materials, allowing an operator to couple the external drive apparatus to the mixing assembly from a distance may be beneficial for protecting the physical safety of the operator.

At operation 1406, the external drive apparatus may impart rotational torque for rotating the mixing assembly within the container. In some embodiments rotating the mixing assembly within the container includes rotating the paddle assembly concentric with the base of the container. That is, the paddle assembly may be rotated about a center or a centroid of the alignment dish or the container base.

In some embodiments, upon completion of the mixing operations, an operator may decouple the elongate hollow section from the external drive operation. In some embodiments, the mixing assembly may remain, in combination with mixed materials, within the container, such that the mixing assembly may be disposed of with the mixed materials. Further, the operator may secure a lid to the opening of the container to contain the mixing assembly and the mixed substance for storage or disposal. As such, the mixing assembly may be “sacrificed” or disposable, thereby reducing chances for spreading or splashing the mixed materials outside of the container.

Although the embodiments have been described in detail, it should be understood that various changes, substitutions and alterations can be made herein without departing from the scope. Moreover, the scope of the present disclosure is not intended to be limited to the particular embodiments of the process, machine, manufacture, composition of matter, means, methods and steps described in the specification.

As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

The description provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As can be understood, the examples described above and illustrated are intended to be exemplary only.

Applicant notes that the described embodiments and examples are illustrative and non-limiting. Practical implementation of the features may incorporate a combination of some or all of the aspects, and features described herein should not be taken as indications of future or existing product plans.

What is claimed is:

1. A mixing assembly for a container comprising:
an alignment dish including a dish surface;
an alignment shaft projecting from the dish surface; and
a paddle assembly coupled to the alignment shaft, the paddle assembly including:
an elongate section for engaging with the alignment shaft, the elongate section having a length greater than an alignment shaft length of the alignment shaft; and
a plurality of blades projecting from the elongate section for mixing contents contained within the container, the plurality of blades distributed about an annular direction on the elongate section,
wherein the paddle assembly is containable within the container and rotatable about the alignment shaft, and wherein the alignment dish is dimensioned to interface with the base of the container to reduce annular motion about the alignment shaft during rotation of the paddle assembly about the alignment shaft.

2. The mixing assembly of claim 1, wherein the paddle assembly containable within the container is retained within the container for storage or disposal.

3. The mixing assembly of claim 1, wherein the alignment dish surface is configured to have a geometric shape substantially similar to a base of the container.

4. The mixing assembly of claim 1, wherein the elongate section for engaging the alignment shaft is an elongate hollow section for receiving the alignment shaft therein.

5. The mixing assembly of claim 4, wherein the elongate hollow section includes an elongate rectangular tube.

6. The mixing assembly of claim 1, wherein the alignment dish is configured to be positioned adjacent the base of the container and is concentric with the base of the container, wherein the alignment dish is removably positioned adjacent the base of the container.

7. The mixing assembly of claim 1, wherein the elongate section includes a sleeve positioned between at least a portion of the elongate section and the alignment shaft.

8. The mixing assembly of claim 7, wherein the sleeve includes polytetrafluoroethylene (PTFE) tubing.

9. The mixing assembly of claim 1, wherein the alignment dish includes one or more projections coupled to the dish surface.

10. The mixing assembly of claim 9, wherein the one or more projections includes at least one of a slat, louver, or a triangular prism.

11. The mixing assembly of claim 1, wherein the alignment shaft is affixed to the alignment dish based on at least one of a seal weld and a tack weld.

12. The mixing assembly of claim 1, comprising a washer positioned between the elongate section and the alignment dish when the alignment shaft is received within the elongate section.

13. The mixing assembly of claim 1, wherein the alignment shaft includes a carbon steel post.

14. The mixing assembly of claim 1, wherein the alignment shaft includes a tapered end positioned proximal to an opening of the container.

15. The mixing assembly of claim 1, comprising: an annular brush coupled to a second end of the elongate section configured to reduce displacement of the contents from an opening of the container.

16. A paddle assembly for a container comprising:
an elongate section for engaging with an alignment shaft positioned within the container and projecting from an alignment dish positioned in a base of the container, the elongate section having a length greater than an alignment shaft length of the alignment shaft; and
a plurality of blades projecting from the elongate section for mixing contents contained within the container, the blades distributed about an annular direction on the elongate section,
and wherein the paddle assembly is containable within the container and rotatable about the alignment shaft, and wherein during rotation of the paddle assembly about the alignment shaft, the alignment dish is substantially stationary in an annular direction relative to the alignment shaft.

17. The paddle assembly of claim 16, wherein the elongate section for engaging with the alignment shaft is an elongate hollow section for receiving the alignment shaft therein.

18. The paddle assembly of claim 17, wherein the elongate hollow section includes a sleeve, wherein the sleeve is positioned between at least a portion of the elongate hollow section and the alignment shaft during rotation of the paddle assembly about the alignment shaft.

19. The paddle assembly of claim 18, wherein the sleeve includes polytetrafluoroethylene tubing.

20. The paddle assembly of claim 17, wherein the elongate hollow section include an elongate rectangular tube.

21. The paddle assembly of claim 16, comprising a washer positioned between the elongate section and the alignment dish when the alignment shaft is received within the elongate section.

22. The paddle assembly of claim 16, comprising an annular brush coupled to a second end of the elongate section configured to reduce displacement of the contents from an opening of the container.

23. A method of mixing contents within a container comprising:
positioning a mixing assembly within the container, the mixing assembly including a paddle assembly, wherein the paddle assembly includes an elongate section engaging with an alignment shaft positioned within the container and projecting from an alignment dish positioned in a base of the container, the elongate section having a length greater than an alignment shaft length of the alignment shaft;
coupling an external drive apparatus to the mixing assembly via the elongate section; and
rotating, via the external drive apparatus, the mixing assembly within the container.

24. The method of claim 23, wherein the elongate section engaging with an alignment shaft is an elongate hollow section.

25. The method of claim 23, comprising:
decoupling the elongate section of the external drive apparatus; and
securing a lid to the opening of the container to contain the mixing assembly and the mixed substance within the container for storage or disposal.

26. The method of claim 23, comprising inserting, into the container, an immobilization reagent for mixing with the contents within the container.

27. The method of claim 23, wherein positioning the mixing assembly within the container includes positioning the alignment dish within the base of the container such that the alignment shaft is positioned at a centroid of the base of the container,
and wherein rotating the mixing assembly within the container includes rotating the paddle assembly concentric with the base of the container.

28. The method of claim 23, wherein coupling the external drive apparatus to the mixing assembly via the elongate section includes mating a socket-shaped shaft end of the external drive apparatus to a coupling end of the elongate section.

29. The method of claim 23, wherein coupling the external drive apparatus to the mixing assembly via the elongate section includes inserting an external drive apparatus shaft end within a recessed end of the elongate section.
